(19) United States
(12) Patent Application Publication
(10) Pub. No.: US 2014/0204297 A1
(43) Pub. Date: Jul. 24, 2014

(54) Light Tunable Device

(71) Applicant: Kuo-Ching Chiang, New Taipei City (TW)

(72) Inventor: Kuo-Ching Chiang, New Taipei City (TW)

(21) Appl. No.: 14/158,761

(22) Filed: Jan. 17, 2014

(30) Foreign Application Priority Data
Jan. 18, 2013 (TW) 102102091

(51) Int. Cl. G02F 1/133; H05B 33/08; H01J 29/98

(52) U.S. Cl. CPC G02F 1/13306; H01J 29/98; H05B 33/08; Y10S 977/939; B82Y 99/00
USPC 349/34; 315/294; 977/939

(57) ABSTRACT

The present invention discloses a light tunable device includes two substrates, a light tunable layer sealed between the two substrates, two electrodes formed on the two substrates, a tuning device coupled to the two electrodes to control bias for the two electrodes to control the status of the light tunable layer to have at least three statues.

### CROSS-REFERENCE TO RELATED APPLICATION

The present application claims priority to the TAIWAN Patent Application Serial Number 102102091 of Jan. 18, 2013, which is herein incorporated by reference in its entirety.

### TECHNICAL FIELD

The present invention generally relates to a film, and especially to a light tunable film.

### DESCRIPTION OF THE RELATED ART

Recently, a lot of energy saving product are released.

Taiwan Patent M320081 disclosed an electronic curtain with polyvision privacy glass controlled by electricity to adjust the glass light transmission. The patent uses liquid crystal sealed between two glasses to achieve the purpose. However, the prior art may only offer on and off states.

### SUMMARY

The present invention is related to a film with following characteristics.

In one aspect, a light tunable device, comprises two substrates; a light tunable layer sealed between the two substrates; two electrodes formed on the two substrates; a tuning device coupled to the two electrodes to control bias for the two electrodes to control the status of the light tunable layer to have at least three statues.

In one embodiment, the light tunable layer includes liquid crystal, wherein the tuning device controls row or column status of the two electrodes to provide at least on status, off status and intermediate status between the on status, the off status. Alternatively, the light tunable layer includes liquid crystal, wherein the tuning device controls orientation angle of the liquid crystal to provide at least on status, off status and intermediate status between the on status, the off status.

In another embodiment, the light tunable layer includes field emission devices, wherein the tuning device controls row or column status of the two electrodes to provide at least on status, off status and intermediate status between the on status, the off status. The field emission devices include CNT emitter.

In another example, the light tunable layer includes fluorescent substances, wherein the tuning device controls row or column status of the two electrodes to provide at least on status, off status and intermediate status between the on status, the off status.

### BRIEF DESCRIPTION OF THE DRAWINGS

FIG. 1 shows one of the embodiments of the present invention.

FIG. 2 shows the embodiment of the present invention.

FIG. 3 shows the embodiment of the present invention.

### DETAILED DESCRIPTION

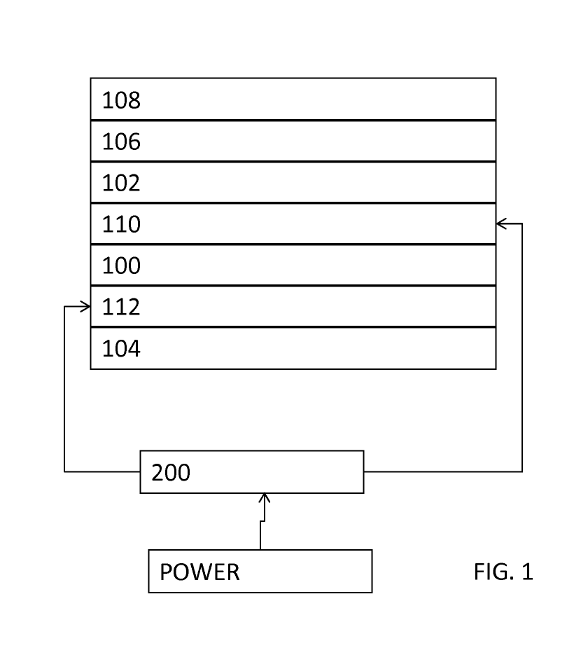

The present invention discloses a film in FIG. 1. A light tunable layer 100 sealed between two transparent substrates 102 and 104. An adhesive layer 106 is formed on one of the two substrates. The light transmitting rate can be adjusted by altering the status of the light tunable layer 100. The substrate may be glass, quartz, polymer such as PC, PMMA, Polyethylene Terephthalate (PET) and the like. UV, blur ray filter or the combination 108 is directly or indirectly formed on the substrate 102 or 104.

The light tunable layer 100 includes liquid crystal molecules. Two electrodes formed on the substrates 102 and 104. The material for the electrodes maybe CNT, conductive polymer, ITO, graphene. Two electrodes are coupled to the power energy.

The prior art only two status, namely, on and off. The present invention includes a light tuning device to control the bias with different voltages to the electrodes, thereby controlling the orientation angle of the liquid crystal molecules, to achieve the purpose of fine tune the status of LC. Under different LC orientation angle, the light transmission rate will different.

Another embodiment to control the light passing rate is to control the status of different row, column electrodes. For example, some of the row and column electrodes are off, others row and column is on to control some LCs are on and others are off status, thereby controlling the light transmission rate. For example, even row electrodes are in on status and odd row electrodes are in off status, vise verse. The even column electrodes are in on status and odd column electrodes are in off status, vise verse. The three (four) times electrodes row (column) are on, others are off, vise verse.

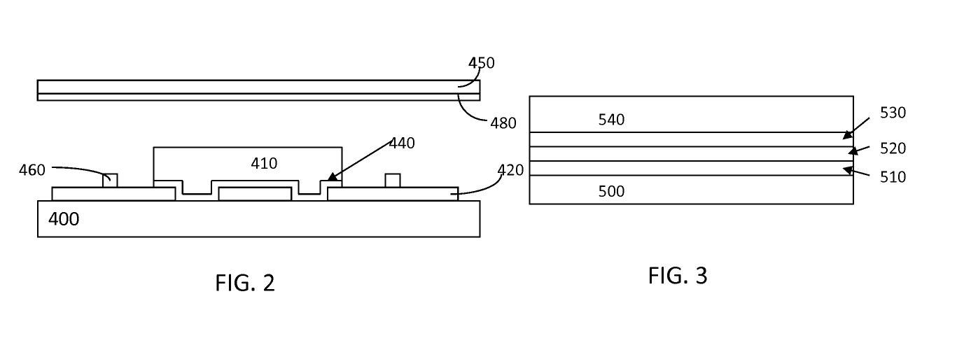

In another embodiment, field emission devices are employed to replace the LC as shown in FIG. 2. A transparent electrode 420 is formed on a substrate 400. The material for the electrode and substrate may be similar with the above embodiment. The transparent electrodes 420 may be made of indium tin oxide (ITO) and may be used as the emitter electrodes. Stacked gate 410 that cover a portion of the transparent electrodes 420 are formed on the glass substrate 400. Emitters 460 that emit electrons are formed on a portion of the transparent electrode 420. Each stacked gate 410 includes a mask layer 440 that covers a portion of the transparent electrodes, and is formed by UV photolithograph mask. The mask layer 440 is preferably transparent to visible light, but opaque to ultra violet rays and can be made of an amorphous silicon layer. The silicon layer will be transparent when the thickness is thin enough. A stacked gate 410 structure includes first insulating layer/a gate electrode/a second insulating layer/focus gate electrode, sequentially formed over the substrate. The gate insulating layer is preferably a silicon oxide thin film with a thickness of 2 mu.m or more and the gate electrode is made of chrome with a thickness of about 0.25 .mu.m. The gate electrode is used for extracting an electron beam from the emitter. The focus gate electrode performs as a collector for collecting electrons emitted from emitter so that the electrons can reach a fluorescent film 480 disposed above the emitter 460. Referring to FIG. 2, a front panel (substrate) 450 is disposed upward and above the stacked gate. A fluorescent film 480 is attached to a bottom surface of the front panel 450 that faces the stacked gate and a direct current voltage is applied to the fluorescent film 480 to emit color. The fluorescent substance may emit color light by mixing the emitted light if the thin film with R, G, B fluorescent substances. Preferably, the fluorescent substances emit red, green, and blue visible light when excited by the electron beam is evenly distributed on the fluorescent film 480. Spacer separating the front panel 450 from the stacked gate is a black matrix layer and is not shown for convenience. The emitter may be made of CNT.

Similarly, a light tunable device 200 is provided for the electrodes of the present invention to adjust brightness of the electronic curtain. The present invention can offer multiple status which is better than two-status prior art. The embodiment to control the light passing rate is to control the status of different row, column electrodes to allow different row and column emitter to perform. For example, some of the row and column electrodes are off, others row and column is on to control some emitter are on and others are off status, thereby controlling the light transmission rate. For example, even row electrodes are in on status and odd row electrodes are in off status, vise verse. The even column electrodes are in on status and odd column electrodes are in off status, vise verse. The three (four) times electrodes row (column) are on, others are off, vise verse. The random row or column may be on, other may be off to provide gray scale pattern.

In another embodiment, as shown in FIG. 3. The device includes a transparent electrode 510 on a transparent substrate 500. A fluorescent film or power 520 is attached to an upper surface of the lower transparent electrode 510. Preferably, the fluorescent substance emits color light. The present invention includes three such devices that separately in red components, green components, and blue component. The same color is suitable as well. Each irradiates single color light. Different powder will emit different color. An upper transparent electrode 530 is formed on the fluorescent film or power 520. A second transparent substrate 540 is formed on the transparent electrode 540. A bias is applied on the electrodes to inject hole and electron, thereby exciting the fluorescent substances by the combination of the electron and hole to emit red, green, or blue visible light depending on the compound of the fluorescent substances.

The present invention may be employed in gargle, window, glasses, wind screen, bathroom, projection screen, hamlet and the like.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A light tunable device, comprising:
two substrates;
a light tunable layer sealed between said two substrates;
two electrodes formed on said two substrates;
a tuning device coupled to said two electrodes to control bias for said two electrodes to control the status of said light tunable layer to have at least three statues.

2. The device according to claim 1, wherein said light tunable layer includes liquid crystal, wherein said tuning device controls row or column status of said two electrodes to provide at least on status, off status and intermediate status between said on status, said off status.

3. The device according to claim 1, wherein said light tunable layer includes liquid crystal, wherein said tuning device controls orientation angle of said liquid crystal to provide at least on status, off status and intermediate status between said on status, said off status.

4. The device according to claim 1, wherein said light tunable layer includes field emission devices, wherein said tuning device controls row or column status of said two electrodes to provide at least on status, off status and intermediate status between said on status, said off status.

5. The device according to claim 4, wherein said field emission devices includes CNT emitter.

6. The device according to claim 4, wherein said one of said substrates includes fluorescent film.

7. The device according to claim 1, wherein said light tunable layer includes fluorescent substances, wherein said tuning device controls row or column status of said two electrodes to provide at least on status, off status and intermediate status between said on status, said off status.
